(19) United States
(12) Patent Application Publication
(10) Pub. No.: US 2012/0084994 A1
(43) Pub. Date: Apr. 12, 2012

(54) APPARATUS AND METHOD OF DRYING AND SANITIZING SPORTS GEAR

(76) Inventor: Jeff Alston, Pittsburgh, PA (US)

(21) Appl. No.: 13/251,258

(22) Filed: Oct. 2, 2011

Related U.S. Application Data
(60) Provisional application No. 61/390,277, filed on Oct. 6, 2010.

(51) Int. Cl. F26B 19/00

(52) U.S. Cl. 34/417; 34/90

(57) ABSTRACT

An apparatus and method of drying and sanitizing sports gear or other clothing includes an upward-extending rack; a support base to support the rack; a plurality of arms on the rack to support the clothing, the arms angled like the arms of a tree; an ozone generator; and a removable, flexible enclosure that covers the rack and is secured to the rack so as to retain the ozone near to the clothing.

### RELATED APPLICATIONS

This application claims the benefit of the filing date of U.S. Patent Application No. 61/390,277, filed Oct. 6, 2010, which is incorporated herein by reference in its entirety.

### BACKGROUND OF THE INVENTION

The present invention generally relates to apparatus to handle clothing and more specifically to an apparatus and method of drying and sanitizing sports gear.

After using sports equipment, the equipment may get wet and sweaty. To keep such equipment well maintained and ready to use again safely, drying and sanitizing the equipment is well recommended.

It would be desirable to have an apparatus for drying and sanitizing personal sports equipment.

### SUMMARY OF THE INVENTION

In one aspect of the present invention, a device to dry equipment includes an upward-extending rack; a support base to support the rack; a plurality of arms on the rack to support the equipment; an ozone generator; and an enclosure to retain the ozone near to the equipment.

In another aspect of the present invention, a device to dry sweat from clothing includes an upward-extending rack; a support base to support the rack; a plurality of arms on the rack to support the clothing, the arms angled like the arms of a tree; an ozone generator; and a removable, flexible enclosure that covers the rack and is secured to the rack so as to retain the ozone near to the clothing.

In yet another aspect of the present invention, a method of drying equipment includes supporting the equipment upon arms of an upward-extending rack; generating ozone; and enclosing the rack within a removable enclosure that retains the ozone near to the equipment.

### BRIEF DESCRIPTION OF THE DRAWINGS

FIG. 1 depicts a perspective view of an embodiment of a drying and sanitizing sports gear apparatus in use according to the present invention;

FIG. 2 depicts an embodiment of the unloaded apparatus of FIG. 1; and

FIG. 3 depicts an embodiment of the drying rack of FIG. 1.

### DETAILED DESCRIPTION

The preferred embodiment and other embodiments, which may be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides an apparatus and a method for drying and sanitizing personal sports gear.

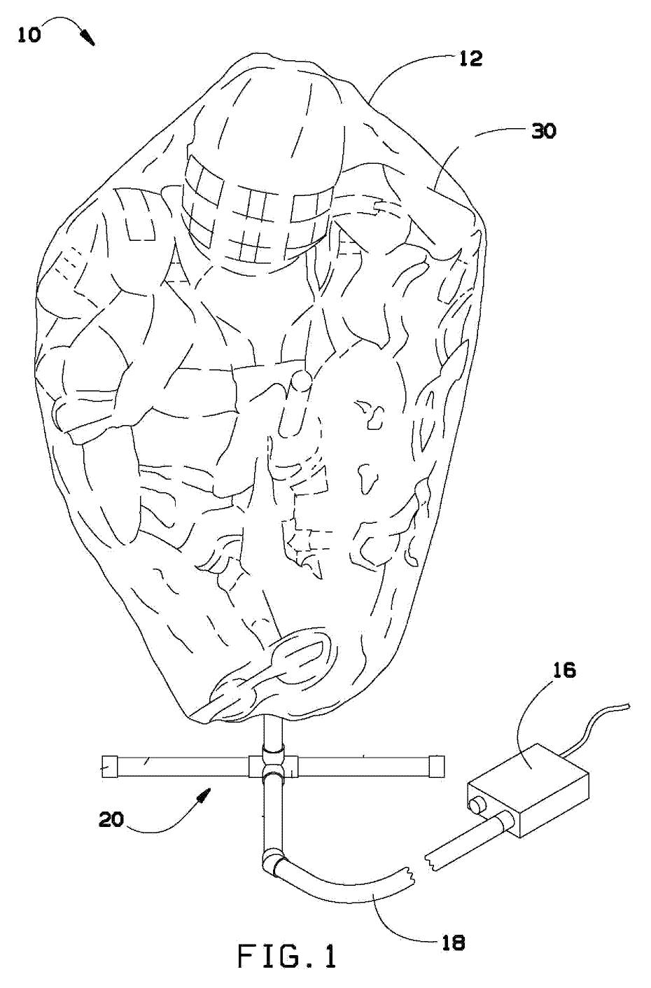

As depicted in FIG. 1, an embodiment of a drying and sanitizing sports gear apparatus 10 may include a drying rack 20. Drying rack 20 may have a support base and may extend upward like a tree with angled arms. When the apparatus 10 is in use, sports equipment 30 may be set on the arms, such as gloves, skates, pads and helmet. The support base may be cross shaped or star shaped. Embodiments of drying rack 20 may be constructed from tubular material such as pipes, which may be perforated or open ended. Air and ozone may be blown into the equipment for drying and sanitizing. An ozone generator 16 may be coupled to drying rack 20. The coupling could be a direct connection or with a hose 18. A flexible enclosure 12 may be placed over the drying rack 20, which may be loaded with sports gear/equipment 30 and secured at the bottom to contain the ozone for the duration of a treatment. The flexible enclosure may be a leak proof plastic bag that may be secured at the base with a fastener.

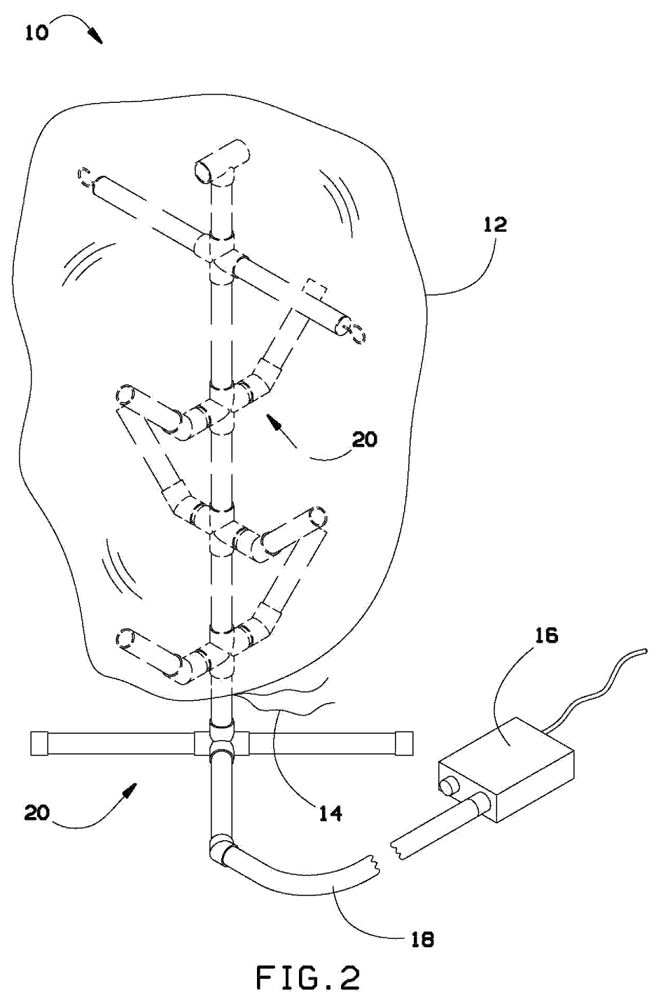

As depicted in the embodiment if FIG. 2, drying rack 20 may extend upward like a tree with angled arms. A support base and the arms may be reconfigured to accommodate different types of equipment. The apparatus 10 may be used as a drying/sanitizing rack for sports equipment and other items worn by humans such as coats, shoes, boots, or any article of clothing that need to be dried and or sanitized. The ozone generator 16 may be customized with options such as timers, variable output levels, fan speeds. Longer exposure to ozone and or to higher concentration of ozone increases the effectiveness of sanitization. The flexible enclosure or cover 12 could be commercially available household plastic bag or it could be custom made from airtight material with zippers or tent like features. Fastener 14 is provided to secure flexible enclosure 12 over drying rack 20. Cinching strap, adhesive tapes and likes could be used as fastener 14.

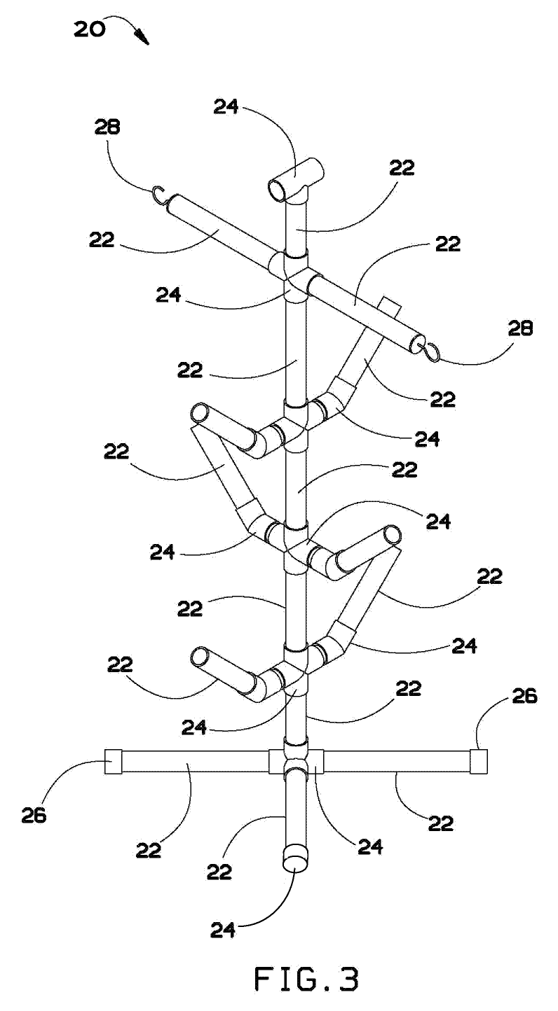

As depicted in the embodiment of FIG. 3, a drying rack 20 shape and height may be reconfigurable to accommodate varying type of sport gears and equipments. In one implementation, the height of drying rack 20 stands approximately 4.5 feet tall. Drying rack 20 may be made of several tubular materials such as metal or polyvinyl chloride (PVC) piping. Drying rack 20 may be assembled from a plurality of commercially available parts, hollow tube/pipes 22, hollow tube/pipe fittings 24, end caps 26 and hooks or clasps 28.

Another aspect of the present invention provides a method for drying and sanitizing personal sports gear. The method may allow setting a duration of a sanitization time. It may also provide a means to set an optimum ozone level provided by the ozone generator.

Embodiments of a rack may have an approximate height of 50″, and width of 24″. A 57″×37″ plastic cover may utilize a ratchet clip to close the cover at the bottom. Embodiments may be for personal, home use, such as a stand which is no more than the height of a person's suit of clothing, such as 6 feet tall. This may allow the drying and sanitizing sports gear apparatus may also be used for drying or sanitizing a single set of clothing worn by people such as coats, shoes, boots, etc. The area of application of the sports gear apparatus may be directed toward personal use; however its broader commercial use is also feasible.

An embodiment of a personal sports gear drying and sanitizing apparatus may comprise: a drying rack having a support base and an upward extended tree-like armed structure, with at least one arm; an ozone generator coupled to drying rack; a flexible enclosure removably covering the drying rack; and a fastener securing the flexible enclosure at the support base.

I claim:

1. A device to dry equipment, comprising:
an upward-extending rack;
a support base to support the rack;
a plurality of arms on the rack to support the equipment;
an ozone generator; and
an enclosure to retain the ozone near to the equipment.

2. The device of claim 1, wherein the equipment is clothing.

3. The device of claim 1, wherein the equipment is sports equipment.

4. The device of claim 1, wherein the thing to be dried is sweat.

5. The device of claim 1, wherein the equipment is sports equipment for an individual user, and the thing to be dried is sweat from the user that has been applied to the equipment during sports.

6. The device of claim 1, wherein the equipment is adapted for personal, home use, the rack having a height of no more than 6 feet.

7. The device of claim 1, wherein the arms are angled liked the arms of a tree.

8. The device of claim 1, wherein the arms are adjustable to accommodate different types of equipment.

9. The device of claim 1, wherein the rack includes a plurality of tubular pipes.

10. The device of claim 1, wherein air and ozone are blown into equipment for drying and sanitizing the equipment.

11. The device of claim 1, wherein the enclosure is a removable, flexible enclosure that covers the rack

12. The device of claim 1, wherein the enclosure is secured to the rack near a bottom of the enclosure with a fastener, so that the enclosure generally retains the ozone and the ozone helps dry the equipment.

13. The device of claim 1, wherein the enclosure is a generally air-tight plastic bag.

14. A device to dry sweat from clothing, comprising:
an upward-extending rack;
a support base to support the rack;
a plurality of arms on the rack to support the clothing, the arms angled like the arms of a tree;
an ozone generator; and
a removable, flexible enclosure that covers the rack and is secured to the rack so as to retain the ozone near to the clothing.

15. A method of drying equipment, comprising:
supporting the equipment upon arms of an upward-extending rack;
generating ozone; and
enclosing the rack within a removable enclosure that retains the ozone near to the equipment.

16. The method of claim 15, further comprising:
securing the rack near a bottom of the enclosure with a fastener, so that the enclosure generally retains the ozone and the ozone helps dry the equipment.
